(19) United States
(12) Patent Application Publication
(10) Pub. No.: US 2003/0039354 A1
(43) Pub. Date: Feb. 27, 2003

(54) FIFO architecture with in-place cryptographic service

(76) Inventors: David E. Kimble, Carrollton, TX (US); Mitsuru Shimada, Dallas, TX (US); Navin Chander, Plano, TX (US)

Correspondence Address: TEXAS INSTRUMENTS INCORPORATED, P O BOX 655474, M/S 3999, DALLAS, TX, 75265

(21) Appl. No.: 09/941,006

(22) Filed: Aug. 27, 2001

(51) Int. Cl. H04K 1/06

(52) U.S. Cl. 380/37

(57) ABSTRACT

A FIFO is implemented as a buffer to encrypt/decrypt packet data and return the data to the same location where it was initially stored. No additional buffer or difficult buffer size decision is therefore required to compensate for the latency associated with the encryption/decryption. The FIFO implementation includes primary and secondary pointers. The primary pointers are available to the transmit/receive circuitry and the secondary pointers are used by the cryptographic circuit. When data is initially loaded into the FIFO, the FIFO does not report data availability to the primary user until the secondary user (cryptographic service) has read a block and returned the block to the same location. The FIFO is implemented via a single port RAM. Blocks are based on the encryption block size. The FIFO similarly reports packet availability based on application packet sizes (such as 188 MPEG2 transport stream packets).

### BACKGROUND OF THE INVENTION

1. Field of the Invention

This invention relates generally to encryption/decryption techniques, and more particularly to a FIFO architecture with in-place cryptographic service.

2. Description of the Prior Art

Known encryption/decryption techniques typically require multiple rounds (or stages) to complete, causing latency, typically as many as 16 clock cycles. When processing real time packet transmissions/reception, this latency must be accommodated by buffers, otherwise the cryptographic service must run at up to sixteen times the data transmission clock frequency.

In view of the foregoing, it is desirable to provide a method and structure for providing cryptographic service that does not require additional buffers or difficult buffer size decisions to compensate for latency and that is not required to run faster than the data transmission clock frequency.

### SUMMARY OF THE INVENTION

The present invention is directed to a FIFO that is implemented as a buffer to encrypt/decrypt packet data and return the data to the same location where it was initially stored. No additional buffer or difficult buffer size decision is therefore required to compensate for the latency associated with the encryption/decryption. The FIFO implementation includes primary and secondary pointers. The primary pointers are available to the transmit/receive circuitry and the secondary pointers are used by the cryptographic circuit. When data is initially loaded into the FIFO, the FIFO does not report data availability to the primary user until the secondary user (cryptographic service) has read a block and returned the block to the same location. The FIFO is implemented via a single port RAM. Blocks are based on the encryption block size. The FIFO similarly reports packet availability based on application packet sizes (such as 188 MPEG2 transport stream packets).

According to one aspect of the invention, a FIFO is implemented as a buffer to encrypt/decrypt packet data and return the data to the same location where it was initially stored eliminating the need for a dedicated cryptographic service (latency) buffer for storing received data.

According to another aspect of the invention, a FIFO is implemented as a buffer to encrypt/decrypt packet data and return the data to the same location where it was initially stored to provide an encryption/decryption engine that can run with slower clock speeds than that required using known encryption/decryption engines.

According to yet another aspect of the invention, a FIFO is implemented as a buffer to encrypt/decrypt packet data and return the data to the same location during the time between packets, effectively smoothing the timeline.

According to still another aspect of the invention, a FIFO is implemented as a buffer to encrypt/decrypt packet data and return the data to the same location using reduced clock frequency requirements on the cryptographic engine, saving power and logic gates.

According to still another aspect of the invention, a FIFO is implemented as a buffer to encrypt/decrypt packet data and return the data to the same location using a flexible configuration that allows packet parsing or filtering in combination with the cryptographic service.

According to still another aspect of the invention, a FIFO is implemented as a buffer to encrypt/decrypt packet data and return the data to the same location using only a single port RAM.

According to still another aspect of the invention, a FIFO is implemented as a buffer to encrypt/decrypt packet data and return the data to the same location in which the adaptation fields and various other fields are not scrambled, while the payload field is scrambled.

### BRIEF DESCRIPTION OF THE DRAWINGS

Other aspects, features and advantages of the present invention will be readily appreciated as the invention becomes better understood by reference to the following detailed description when considered in connection with the accompanying drawing figure wherein:

FIG. 1 is a block diagram illustrating a well known technique using encryption/decryption service after a FIFO;

FIG. 2 is a block diagram illustrating a well known technique using encryption/decryption service before a FIFO;

FIG. 3 is a block diagram illustrating encryption/decryption service that resides as a part of a FIFO system according to one embodiment of the present invention;

FIG. 4 is a diagram illustrating addressing and data storage associated with the FIFO system shown in FIG. 3; and

FIG. 5 is a block diagram illustrating a more complex FIFO architecture that employs a switcher and a single encryption algorithm that resides as a part of the FIFO architecture to accommodate converting encrypted data associated with two paths according to another embodiment of the present invention.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

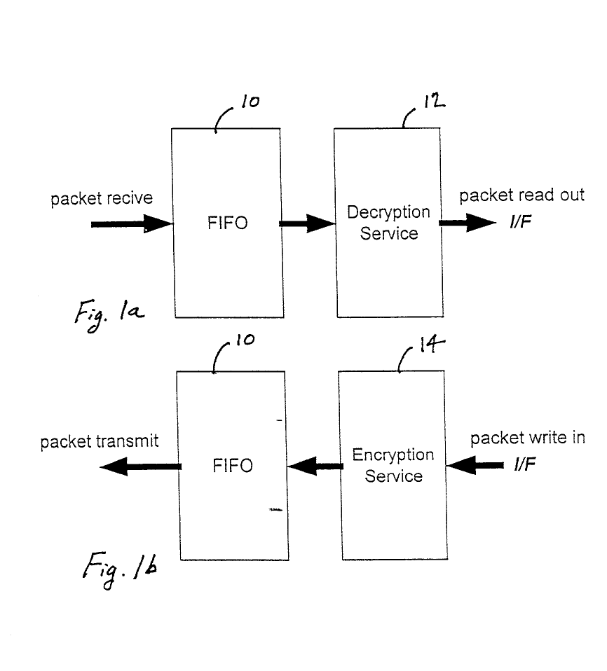

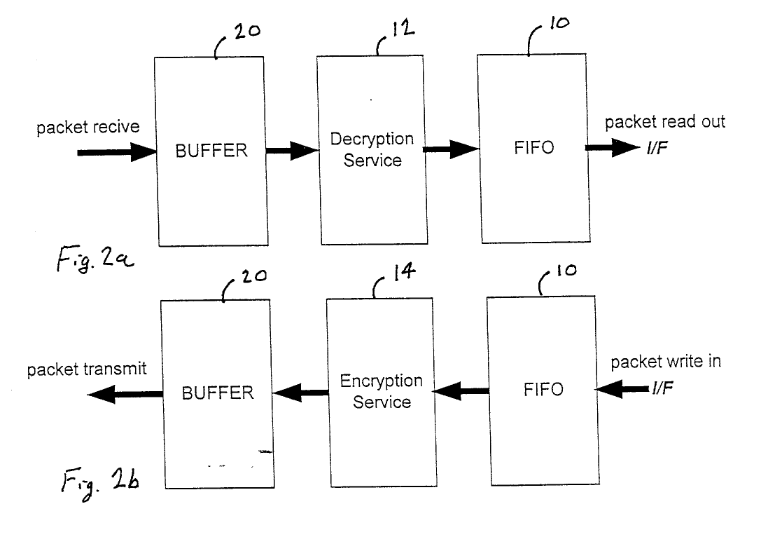

The present invention is best understood by first describing known techniques illustrated herein below with reference to FIGS. 1 and 2 for providing encryption/decryption service in association with a FIFO.

FIGS. 1a and 1b are block diagrams illustrating a well known technique using encryption/decryption service after a FIFO 10. As shown in FIG. 1a, received packets are decrypted by reading out the data from the FIFO 10 through a decryption service 12. Transmitting packets are encrypted by writing the packets in to the FIFO 10 through an encryption service 14 as shown in FIG. 1b. This technique is advantageous since a large buffer is unnecessary. This technique is disadvantageous however, since the speed of the associated encryption/decryption circuit 12, 14 is governed by the I/F speed. Further, special care must be taken when dealing with the FIFO 10 whenever the encryption/decryption content key has changed during the operation, another disadvantage. Yet another disadvantage is associated with the case of packet transmission, in which write operations must take place through encryption logic that requires constant awareness of the encryption logic.

FIGS. 2a and 2b are block diagrams illustrating a well known technique using encryption/decryption service before a FIFO 10. As shown in FIG. 2a, received packets are decrypted on-the-fly and stored into FIFO 10. Transmitting packets shown in FIG. 2b are stored in the FIFO 10 in the form of unencrypted data and are encrypted in the background. This technique is advantageous in that the data in the FIFO 10 is always unencrypted data. In this regard, the encryption/decryption service is transparent to the user. This technique is, however, disadvantageous in that a large buffer 20 is required to fill the speed difference between the packet speed and the encryption/decryption logic speed. Further, a high speed clock may be necessary to run the encryption/decryption logic associated with decryption service 12 and encryption service 14.

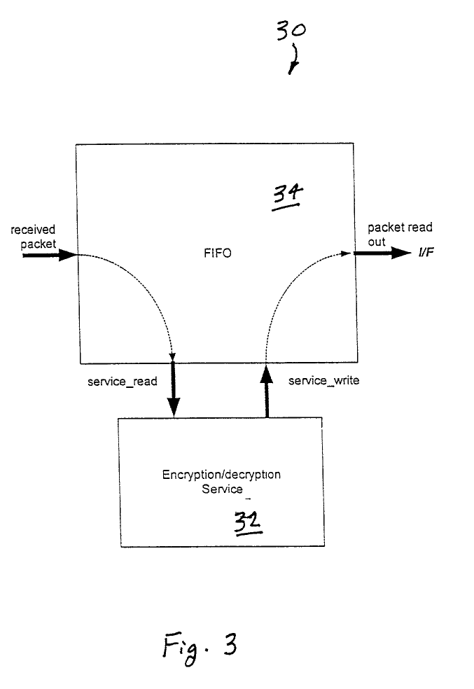

FIG. 3 is a block diagram illustrating encryption/decryption service 32 that resides as a part of a FIFO system 30 according to one embodiment of the present invention. Received packets are first stored into a FIFO 34, then read out by encryption circuitry associated with encryption/decryption service 32 where it is written back into the FIFO 34. Those skilled in the art will readily appreciate that transmitting packets works in substantially the same manner. The encryption/decryption service 32 is not visible to the user, but instead, appears to the user as nothing more than a simple FIFO. No dedicated buffer is necessary to compensate for speed differences since all encryption/decryption takes place inside the FIFO 34. Since the encryption/decryption service 32 is internal only to the FIFO 34, the speed of encryption/decryption is not governed by any physical clock speed; and the encrypted data is more secure when compared with that associated with known encryption/decryption engines.

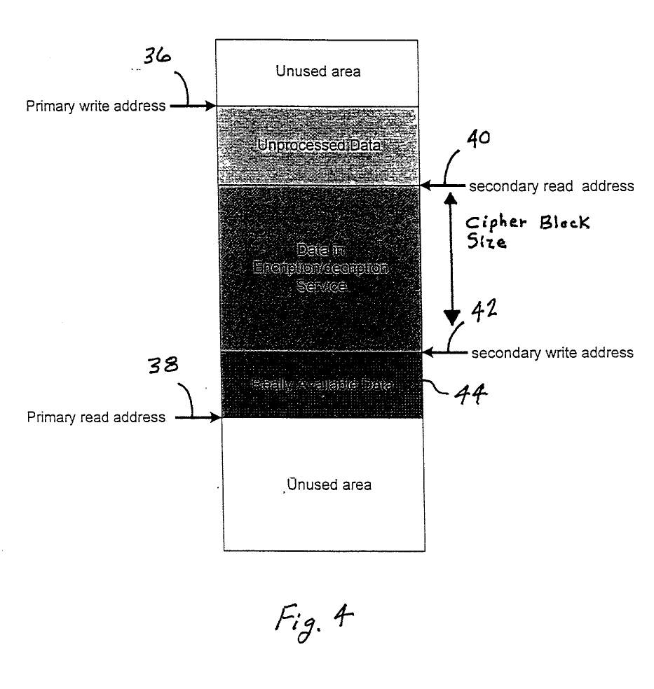

FIG. 4 is a diagram illustrating addressing and data storage associated with the FIFO system 30 shown in FIG. 3. The FIFO 34 can be seen to have four address pointers. The first address pointer 36 is associated with a primary write address that specifies the address written to the FIFO 34. The second address pointer 38 is associated with a primary read address that specifies the address where a user reads out data from the FIFO 34. The third address pointer 40 is associated with a secondary read address that specifies the address read by the encryption/decryption service 32. The fourth address pointer 42 is associated with a secondary write address that specifies where the processed data is written back into the FIFO 34. The data 44 between the secondary write address and the primary read address is available for a user.

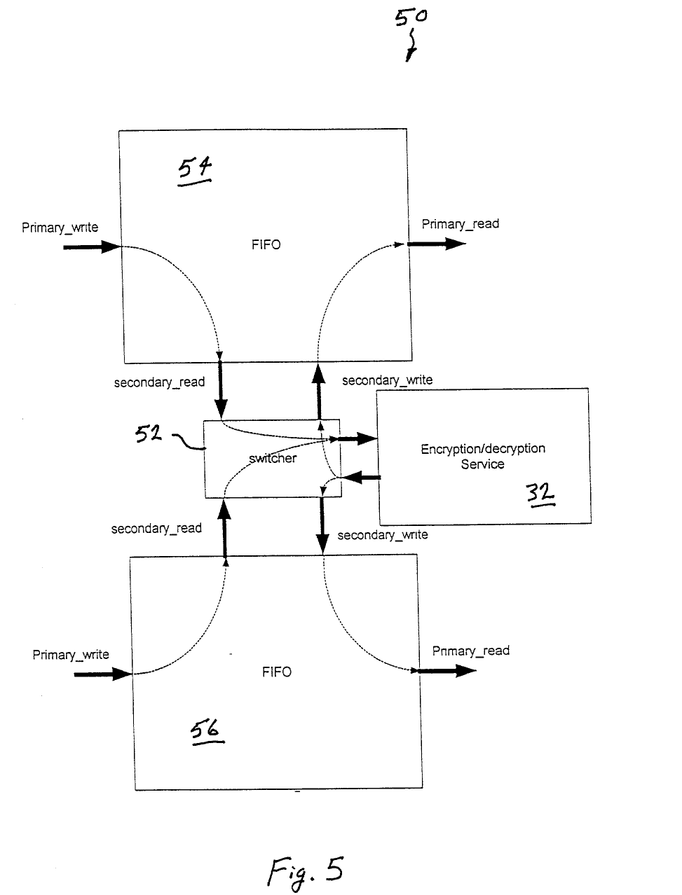

FIG. 5 is a block diagram illustrating a more complex FIFO architecture 50 that employs a switcher 52 and a single encryption algorithm that resides as a part of the FIFO architecture 50 to accommodate converting encrypted data associated with two paths according to another embodiment of the present invention. The encryption/decryption service 32 works in the same manner as described herein before with reference to FIGS. 3 and 4, except that now a switcher 52 is used to multiplex the encryption/decryption service 32 between two different FIFO devices 54, 56 such that data can now be processed in a time sharing manner to accommodate two distinct data paths.

In view of the above, it can be seen the present invention presents a significant advancement in the art of encryption/decryption techniques. Further, this invention has been described in considerable detail in order to provide those skilled in the encryption/decryption art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A cryptographic system comprising:
a first FIFO data storage device having a primary write address to receive unprocessed data via a first data path into the first FIFO data storage device, a primary read address, a secondary read address and a secondary write address; and
an encryption/decryption circuit configured to read the unprocessed data via the secondary read address, selectively encrypt or decrypt the unprocessed data read via the secondary read address to generate processed data, and write the processed data back into the first FIFO data storage device via the secondary write address, such that the processed data written back into the first FIFO data storage device can be read from the first FIFO data storage device via the primary read address.

2. The cryptographic system according to claim 1 wherein the FIFO data storage device is a single port random access memory.

3. The cryptographic system according to claim 1 further comprising:
a second FIFO data storage device having a primary write address to receive unprocessed data via a second data path into the second FIFO data storage device, a primary read address, a secondary read address and a secondary write address; and
a switching circuit configured to multiplex between the first and second FIFO data storage devices such that the encryption/decryption circuit can parallel process the unprocessed data stored in the first and second FIFO data storage devices to generate respective processed data, and write the respective processed data back into the first and second FIFO data storage devices via their respective secondary write addresses, such that the respective processed data written back into the first and second FIFO data storage devices can be read from the first and second FIFO data storage devices via their respective primary read addresses.

4. The cryptographic system according to claim 3 wherein the first and second FIFO data storage devices each comprise a single port random access memory.

5. A cryptographic system comprising:
a first single port random access memory (RAM) configured with a primary write address to receive unprocessed data via a first data path into the single port RAM, a primary read address, a secondary read address and a secondary write address; and
an encryption/decryption circuit configured to read the unprocessed data via the secondary read address, selectively encrypt or decrypt the unprocessed data read via the secondary read address to generate processed data, and write the processed data back into the first single port RAM via the secondary write address, such that the processed data written back into the first single port RAM can be read from the first single port RAM via the primary read address.

6. The cryptographic system according to claim 5 further comprising:
a second single port RAM having a primary write address to receive unprocessed data via a second data path into the second single port RAM, a primary read address, a secondary read address and a secondary write address; and
a switching circuit configured to multiplex between the first and second single port RAMs such that the encryption/decryption circuit can parallel process the unprocessed data stored in the first and second single port RAMs to generate respective processed data, and write the respective processed data back into the first and second single port RAMs via their respective secondary write addresses, such that the respective processed data written back into the first and second single port RAMs can be read from the first and second single port RAMs via their respective primary read addresses.

7. A cryptographic system comprising a first FIFO memory configured with a primary write address to receive unprocessed data into the first FIFO memory via a first data path, a secondary read address to provide access to the unprocessed data such that an external user can retrieve and encrypt or decrypt the unprocessed data, a secondary write address to receive data back into the first FIFO memory that has first been read from the first FIFO memory and encrypted or decrypted, and a primary read address to provide access to data that has been read from the first FIFO memory, encrypted or decrypted, and written back into the first FIFO memory via the secondary write address.

8. The cryptographic system according to claim 7 wherein the first FIFO memory is a single port random access memory.

9. The cryptographic system according to claim 7 further comprising an encryption/decryption circuit configured to read the unprocessed data stored in the first FIFO memory via the secondary read address, selectively encrypt or decrypt the unprocessed data that has been read to generate processed data, and write the processed data back into the first FIFO memory via the secondary write address, such that the processed data written back into the first FIFO memory can be read from the first FIFO memory via the primary read address.

10. The cryptographic system according to claim 9 wherein the first FIFO memory is a single port random access memory.

11. The cryptographic system according to claim 9 further comprising:
a second FIFO memory having a primary write address to receive unprocessed data via a second data path into the second FIFO memory, a primary read address, a secondary read address and a secondary write address; and
a switching circuit configured to multiplex between the first and second FIFO memory such that the encryption/decryption circuit can parallel process the unprocessed data stored in the first and second FIFO memory to generate respective processed data, and write the respective processed data back into the first and second FIFO memory via their respective secondary write addresses, such that the respective processed data stored in the first and second FIFO memory can be read from the first and second FIFO memory via their respective primary read addresses.

12. The cryptographic system according to claim 11 wherein the first and second FIFO memory each comprise a single port random access memory.

13. A method of performing data cryptography comprising the steps of:
providing a first FIFO memory having a primary write address, a secondary read address, a primary read address, and a secondary write address;
writing data into the first FIFO memory via the primary write address;
reading the written data via the secondary read address;
selectively encrypting or decrypting the read data to generate processed data; and
writing the processed data into the first FIFO memory via the secondary write address.

14. The method according to claim 13 further comprising the step of reading the written processed data via the primary read address.

15. A method of performing data cryptography comprising the steps of:
providing a first FIFO memory having a primary write address, a secondary read address, a primary read address, and a secondary write address;
writing data into the first FIFO memory via its primary write address;
providing a second FIFO memory having a primary write address, a secondary read address, a primary read address, and a secondary write address;
writing data into the second FIFO memory via its primary write address;
providing a switcher configured to multiplex between the first and second FIFO memory secondary read addresses and the first and second FIFO memory secondary write addresses;
multiplexing between the first and second FIFO memory secondary read addresses to selectively access the data written into the first and second FIFO memories;
selectively encrypting or decrypting the multiplexed data to generate processed data;
writing processed data generated from data stored in the first FIFO memory back into the first FIFO memory via its secondary write address; and
writing processed data generated from data stored in the second FIFO memory back into the second FIFO memory via its secondary write address.

16. The method according to claim 15 further comprising the step of reading the processed data written back into the first FIFO memory via its primary read address.

17. The method according to claim 15 further comprising the step of reading the processed data written back into the second FIFO memory via its primary read address.
